(19) United States
(12) Patent Application Publication
(10) Pub. No.: US 2024/0064163 A1
(43) Pub. Date: Feb. 22, 2024

(54) SYSTEM AND METHOD FOR RISK-BASED OBSERVABILITY OF A COMPUTING PLATFORM

(71) Applicant: Booz Allen Hamilton Inc., McLean, VA (US)

(72) Inventors: Ammad Jilani, Austin, TX (US); Jeffrey M. Liott, Milton, DE (US); Stephen Mao, Herndon, VA (US); Steven McDaniel, Washington, UT (US); Gregory McCullough, Austin, TX (US); Arjun Raman, Austin, TX (US); Eric Tang, Oakton, VA (US)

(73) Assignee: Booz Allen Hamilton Inc., McLean, VA (US)

(21) Appl. No.: 18/451,512

(22) Filed: Aug. 17, 2023

Related U.S. Application Data
(60) Provisional application No. 63/398,611, filed on Aug. 17, 2022.

(51) Int. Cl. H04L 9/40; G06F 16/25

(52) U.S. Cl. CPC H04L 63/1425; G06F 16/258; G06F 16/254

(57) ABSTRACT

Exemplary systems and methods are directed to risk-based observability of a platform. Data is received from plural devices from one or more computing environments on a network. The received data is in a raw data format according to the computing environment or platform from which it was received. The received data is converted from the raw format to a structured format. The converted data is enhanced by adding contextual information associated with a corresponding one of the plural devices. A risk analysis is performed on the enhanced data based on one or more risk detection rules applied to the network. One or more tags are applied to the enhanced data based on results of the risk analysis. Data analysis is performed on the enhanced data to identify devices from aggregate sources. The data is sent to one or more destinations on the network based on the applied tags.

### FIELD

The present disclosure relates to a system and method for risk-based observability of a computing platform.

### BACKGROUND

Organizations use comprehensive endpoint security solutions and endpoint protection platforms with automated detection. Threat hunting, threat detection, incident response, and forensic activities are known cybersecurity processes that identify and evaluate data for malicious or suspicious activities that may have previously evaded detection. These threat management activities allow organizations to be proactive in detecting and isolating advanced threats without any advance warning. These solutions work in addition to endpoint security solutions and add advanced technologies to find anomalies, unusual patterns, and other traces of attackers that shouldn't be in systems and files. Endpoint protection platforms leverage data analytics to capture and analyze large volumes of unfiltered endpoint data, and use signature analytics, behavioral analytics and artificial intelligence (AI) to provide high-speed visibility into malicious behaviors that may be initially undetectable.

A large organization may desire to implement endpoint protection systems and threat management activities relative to the data traffic and activity of sub-networks associated with authorized clients. The endpoint protection platforms and threat management applications are vendor-specific and require specified commands, processes and data formatting to implement the desired security solution. As a result, the organization can be presented various network security issues such as (1) choosing between suspicious and/or malicious activity detection and visibility while attempting to handle budget constraints and increasing data sources; (2) dealing with large teams and various data and infrastructure ownership models such as federated networks; (3) dealing with large teams and various data ownership models leading to siloed visibility between architecture and related infrastructure layers across both on-premise and cloud environments; and (4) dealing with disparate activity detection content models and a lack common data standards which creates inequities within the security operations teams and incongruent ability to deploy detection content and data enrichment. These issues can make cybersecurity operations and associated threat management activities cumbersome, inefficient, and costly which leads to vulnerabilities across the entire network.

### SUMMARY

An exemplary system for risk-based observability of a platform is disclosed, the system comprising: a receiver configured to receive data from plural devices associated with one or more computing environments on a network, the received data having a raw format according to the associated computing environment; a processor configured to: convert the raw format of the received data to a structured format; enhance the converted data by adding contextual information associated with a corresponding one of the plural devices; perform a risk analysis of the enhanced data based on risk content applied to the network; and apply one or more tags to the enhanced data based on results of the risk analysis; perform data analysis on the enhanced data to render synthesized and/or prioritized data for identifying one or more of the plural devices from an aggregate source; and a transmitter configured to send the rendered synthesized and/or prioritized data to one or more destinations on the network based on the one or more applied tags.

An exemplary method for risk-based observability of a platform is disclosed, the method comprising: receiving, by a receiver of a computing device, data from plural devices associated with one or more computing environments on a network, the received data having a raw format according to the associated computing environments; converting, by a processor of the computing device, the raw format of the received data to a structured format; enhancing, by the processor of the computing device, the converted data by adding contextual information associated with a source of the respective data; performing, by the processor of the computing device, a risk analysis on the enhanced data based on risk content applied to the network; applying, by the processor of the computing device, one or more tags to the enhanced data based on results of then risk analysis; performing, by the processor of the computing device, data analysis on the enhanced data to render synthesized and/or prioritized data for identifying one or more of the plural devices from an aggregate source; and sending, by a transmitter of the computing device, the rendered synthesized and/or prioritized data to one or more destinations on the network based on the one or more applied tags.

An exemplary computer readable medium storing program code for performing a method for risk-based observability of a platform, when placed in communicable contact with computing device the program code causing the computing device to perform operations comprising: receiving, by a receiver of a computing device, data from plural devices associated with one or more computing environments on a network, the received data having a raw format according to the associated computing environment; converting, by a processor of the computing device, the raw format of the received data to a structured format; enhancing, by the processor of the computing device, the converted data by adding contextual information associated with a source of the respective data; performing, by the processor of the computing device, a risk analysis on the enhanced data based on one or more risk detection rules applied to the network; applying, by the processor of the computing device, one or more tags to the enhanced data using results of the analysis; performing, by the processor of the computing device, data analysis on the enhanced data to render synthesized and/or prioritized data for identifying one or more of the plural devices from an aggregate source; and sending, by a transmitter of the computing device, the rendered synthesized and/or prioritized data to one or more destinations on the network based on the one or more applied tags.

### BRIEF DESCRIPTION OF THE DRAWINGS

Exemplary embodiments are best understood from the following detailed description when read in conjunction with the accompanying drawings. Included in the drawings are the following figures:

FIG. 1 illustrates stages of data flow in accordance with an exemplary embodiment of the present disclosure.

FIG. 2A illustrates a computing device according to an exemplary embodiment of the present disclosure.

FIG. 2B illustrates an exemplary computing environment according to an exemplary embodiment of the present disclosure.

FIG. 2C illustrates a block diagram of a hardware configuration of a computing device 250 in accordance with an exemplary embodiment of the present disclosure.

FIG. 3 illustrates a method for risk-based observability of a platform in accordance with an exemplary embodiment of the present disclosure.

FIG. 4 illustrates a use case for risk-based observability in accordance with an exemplary embodiment of the present disclosure.

FIG. 5 illustrates a use case for a Federated Data Streaming model in accordance with an exemplary embodiment of the present disclosure.

Further areas of applicability of the present disclosure will become apparent from the detailed description provided hereinafter. It should be understood that the detailed descriptions of exemplary embodiments are intended for illustration purposes only and, therefore, are not intended to necessarily limit the scope of the disclosure.

### DETAILED DESCRIPTION

Exemplary embodiments of the present disclosure are directed to a system and method for risk-based observability of a platform. The network can include plural edge devices, which can manage and correlate data at the edge. The system gathers data on every device on a network and determines a device's importance and/or risk to the network. Data can be analyzed in real-time at the device-level upon entry to the network. The data can be enriched and tagged at the edge, such that only anomalous data is separated, filtered, and compressed before being sent to another location in the network for further evaluation. The system can receive data in various formats, structure the data in an open format that is consistent with an organization's priorities and risks, help identify root cause of threats and/or incidents, and group related alerts that can be addressed by a single action to track them to their origin. The data analysis allows the system to inspect an entire network and/or application stack, understand the impact of the data and any signatures or behavioral anomalies to your organization, and prioritize the anomalies in an order for response. The system serves as a single agnostic detection system that can look for data threat patterns and anomalies across multiple data formats. The exemplary embodiments of the present disclosure support a vendor-agnostic approach for Hunt, Incident Response, and Forensics activities, by consolidating and performing the actions required in a multi-vendor environment under one platform.

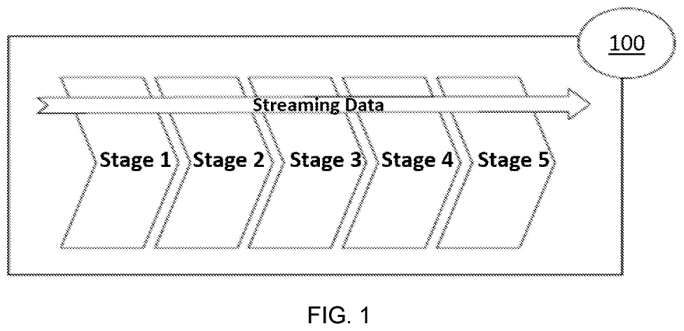

FIG. 1 illustrates stages of data flow in accordance with an exemplary embodiment of the present disclosure.

The data flow 100 of FIG. 1 can take place within one or more computing devices on a network. The computing device can be a local computing device configured to operate in a distributed computing environment including a local endpoint, an on-premise data center, cloud computing, an air-gapped computing arrangement, or other computing arrangement as desired. According to another exemplary embodiment, the computing device can be a local device configured to operate in an enterprise network environment. In either implementation, the computing device can be configured with any number of applications and/or tools that generate data and/or capture data from an endpoint in the network, the cloud, or an edge computing device. According to an exemplary embodiment, the endpoint devices can include a sensor, smart device, laptop computing device, desktop computing device, tablet or any other suitable endpoint device or network location as desired.

As shown in the data flow 100 of FIG. 1, data is received or ingested at the computing device from one or more other computing devices on the network (Stage 1). The network can include computing devices arranged and/or configured to operate as a private data center, a managed data center, and/or a virtual data center such as a cloud. According to an exemplary embodiment, the data can be received over the network as streaming data or batching data. The platform provides several improvements and value over known systems by its ability to receive streaming data that can be received in a raw format according to a computing environment of a corresponding one of the plural devices. For example, the raw format for data can include a proprietary data structure associated with a vendor-specific application or platform (e.g., Amazon Web Service, Google Cloud Platform). The data can be received by the computing device through any suitable receiving device which, as will be described in further detail, can be a combination of hardware and software components. The received data is sourced from at least one of: signature-based alerts grouped by application, device, and user; host-based logs; network-based logs; cyber compliance audits; and network user activity. According to an exemplary embodiment, meta tags can be applied to the data to identify the source in-line (or while data is being streamed and processed). The meta tags can also be used to specify the data type of the received data. The computing device can include a processor that normalizes the received data by converting the raw format of the received data to a structured or standardized format (e.g., common schema) (Stage 2). For example, the raw format of the received data can be converted or mapped to the data structure of the enterprise computing system into which it was received. The conversion includes extracting specified fields (e.g., date, hostname, message, IP address, etc.) from the data received from the plural computing devices according to a common schema. The processor can enhance the normalized data by adding contextual information associated with a corresponding one of the plural devices (Stage 3). According to an exemplary embodiment, the processor can insert supplemental data and data derived from other sources. For example, the inserted data can include one more objects associated with the enterprise computing system. In addition, the enriching data can include a geographic lookup host or IP address, a bad IP address, a Port to Server Service or Server Process mapping, common vulnerabilities and exposures (CVE) references including those in the national vulnerability database (NVD), industry standard attack enumeration and behavior models (e.g., MITER ATT&K, MITRE D3FEND), or any other suitable location-based information as desired. In another exemplary embodiment, the enriching data can include data correlations, data counters, data aggregations or other suitable data operations (e.g., data analytics) performed by the computing device or network as desired. In yet another exemplary embodiment, the enriching data can include contextual data associated with process or computing events. The contextual data can be stored in cache memory or a database. During the enrichment operation, the processor can also generate traces for observability of the data. The trace data can be used to measure or evaluate the performance or operation between services and/or components in the network.

Following enrichment of the data, the processor can perform a risk analysis based on one or more risk content, which can include risk detection rules or risk detection models, such as threat content or analytics, applied to the network. The processor analyzes the data and identifies data traffic that is normal and data traffic that may be anomalous or contain anomalies. One or more tags are applied to the enhanced data based on results of the risk analysis (Stage 4). For example, the tags serve as indicators that identify factors needed for routing the data and further analysis. The processor applies data analysis to render synthesized and/or prioritized data to identify and persist a device/asset inventory from aggregate sources. According to an exemplary embodiment, the prioritized data can include asset or device inventory data, prioritized score data, or any other suitable data as desired. In addition, the processor filters the normal data so that only the anomalous data remains. The anomalous data is compressed and stored in memory of the computing device. A transmitter of the computing device sends the enhanced data to one or more destinations on the network based on the one or more applied tags (Stage 5). According to an exemplary embodiment, the data can be routed to team or group of an organization that can address or resolve threats and/or incidents associated with the anomalous data. These operation provide an an enhanced threat management response process in which a security team can spend less manual time and less cost processing data.

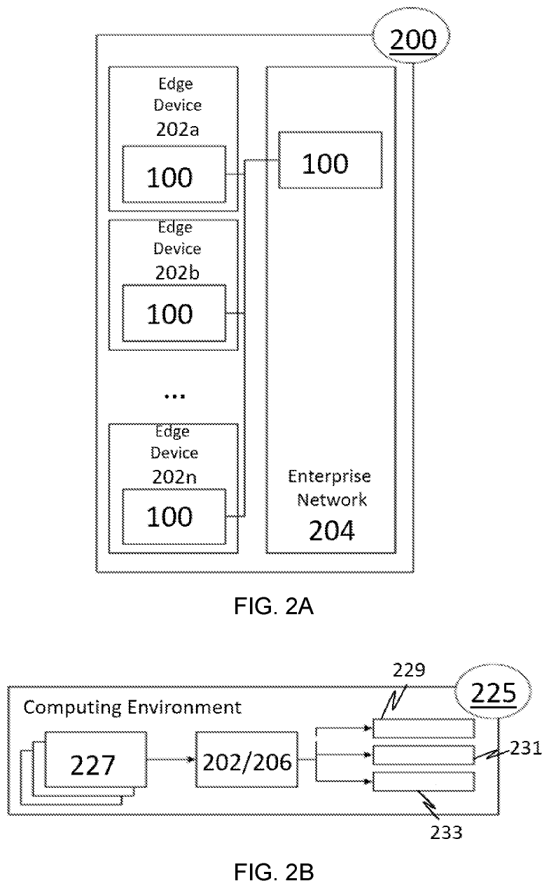

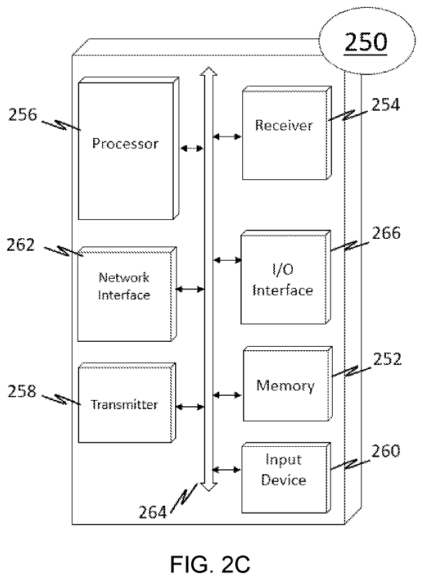

FIG. 2A illustrates a computing device according to an exemplary embodiment of the present disclosure.

As shown in FIG. 2A, exemplary systems 200 associated with the present disclosure can include a distributed computing environment having plural edge devices 202. Each of the plural edge devices can be connected to an enterprise network 204 having at least one server 206. Each of the plural edge devices 202 and the server 206 can be configured to perform one or more of the operations described in FIG. 1. According to an exemplary embodiment, each edge device 202 can be configured to route tagged anomalous data to the server 206 for further analysis, evaluation, and/or resolution of the threat or incident.

FIG. 2B illustrates an exemplary computing environment 225 according to an exemplary embodiment of the present disclosure.

As shown in FIG. 2B, the computing environment 225 according to exemplary embodiments of the present disclosure can include plural data sources 227 that provide streaming data to be evaluated. As already discussed, the plural data sources 227 can include one or more endpoint computing devices, cloud computing devices, or edge computing devices 202a-202n. According to an exemplary embodiment, the endpoint devices can include a sensor, smart device, a desktop computer, tablet computer, laptop computer, or any other suitable endpoint device or network location as desired. The cloud computing devices can include one or more computing devices of a content provider supplying data content which can include data associated with video and audio files, one or more plural computing devices forming a database or data lake, or other suitable computing devices or combination of computing devices as desired. The streaming data can be received in one or more of a computing device 202a-202n or server 206 for performing operations for risk-based observability of a platform. The computing device 202a-202n or server 206 can generate an alert which can also include observability information associated with anomalous data identified from the streaming data. The alert can be routed to one or more teams or groups of an organization, or subsystems of an enterprise network or computing device for resolving and/or addressing the cyber threat or incident. For example, the subsystems can include a Security Information and Event Management (STEM) system 229, a data lake 231, a Security Orchestration, Automation and Response (SOAR) system 233, or any suitable system (e.g., Case Management, Ticket Management, or Communication or Collaboration Tools), network location, and organizational team or group as desired.

FIG. 2C illustrates a block diagram of a hardware configuration of a computing device 250 in accordance with an exemplary embodiment of the present disclosure. As shown in FIG. 2C, the computing device 250 includes memory 252, a receiver 254, a processor 256, and a transmitter 258 which were previously discussed with regard to FIG. 1. The computing device 250 further includes one or more input devices 260, a network interface 262, an internal communication infrastructure 264, and an input/output (I/O) interface 266.

According to exemplary embodiments of the present disclosure, the one or more input devices 260 can be configured to receive commands and/or allow a user to interact (e.g., input data and/or commands) with the computing device. The one or more input devices 260 can include one or more of a physical or virtual keyboard, a touchpad, a mouse or stylus, microphone, camera or any other suitable input device as desired. The receiver 254 can include a combination of hardware and software components configured to receive streaming data from one or more other computing devices connected to the network and/or at the edge, a data lake, the cloud, or any other suitable component on the network as desired. According to exemplary embodiments, the receiver 254 can include a hardware component such as an antenna, a network interface (e.g., an Ethernet card), a communications port, a PCMCIA slot and card, or any other suitable component or device as desired. The receiver 254 can be connected to other devices via a wired or wireless network or via a wired or wireless direct link or peer-to-peer connection without an intermediate device or access point. The hardware and software components of the receiver 254 can be configured to receive data (e.g., streaming data) according to one or more communication protocols and data formats. The receiver 254 can be configured to communicate over a network, such as enterprise network, which may include a local area network (LAN), a wide area network (WAN), a wireless network (e.g., Wi-Fi), a cellular communication network, a satellite network, the Internet, fiber optic cable, coaxial cable, infrared, radio frequency (RF), another suitable communication medium as desired, or any combination thereof. During a receive operation, the receiver 254 can be configured to identify parts of the received data via a header and parse the data signal and/or data packet into small frames (e.g., bytes, words) or segments for further processing at the processor 256. It should be understood that the receiver 254 can be configured as an independent device or have circuitry and components integrated with a network interface 262.

The processor 256 can be a special purpose or a general purpose processing device encoded with program code or software for performing the exemplary functions and/or features disclosed herein. According to exemplary embodiments of the present disclosure, the processor 256 can include a central processing unit (CPU). The processor 256 can be connected to the communications infrastructure 264 including a bus, message queue, or network, multi-core message-passing scheme, for communicating with other components of the computing device 250, such as the memory 252, the one or more input devices 260, the network interface 262, and the I/O interface 266. The processor 256 can include one or more processing devices such as a microprocessor, microcomputer, programmable logic unit or any other suitable hardware processing devices as desired.

The I/O interface 266 can be configured to receive the signal from the processing device 256 and generate an output suitable for a peripheral device via a direct wired or wireless link. The I/O interface 266 can include a combination of hardware and software for example, a processor, circuit card, or any other suitable hardware device encoded with program code, software, and/or firmware for communicating with a peripheral device such as a display device, printer, audio output device, or other suitable electronic device or output type as desired. The I/O interface 266 can also be configured to connect and/or communicate with or in combination with other hardware components provide the functionality of various types of integrated and/or peripheral input devices described herein.

The transmitter 258 can be configured to receive data from the processor 256 and/or memory 252 and assemble the data into a data signal and/or data packets according to the specified communication protocol and data format of a peripheral device or remote device to which the data is to be sent. The transmitter 258 can include any one or more of hardware and software components for generating and communicating the data signal over the internal communication infrastructure 264 and/or via a direct wired or wireless link to a peripheral or remote device. The transmitter 258 can be configured to transmit information according to one or more communication protocols and data formats as discussed in connection with the receiver 254. According to an exemplary embodiment, the receiver 254 and the transmitter 258 can be integrated into a single device and/or housing, or configured as separate and independent devices. According to another exemplary embodiment, the receiver 254 and the transmitter 258 can be configured shared circuitry and components and can be further integrated with the network interface 262.

According to exemplary embodiments described herein, the combination of the memory 252 and the processor 256 can store and/or execute computer program code for performing the specialized functions described herein. It should be understood that the program code could be stored on a non-transitory computer readable medium, such as the memory devices for the computing device 250, which may be memory semiconductors (e.g., DRAMs, etc.) or other tangible and non-transitory means for providing software to the computing device 250. For example, via any known or suitable service or platform, the program code can be deployed (e.g., streamed and/or downloaded) remotely from computing devices located on a local-area or wide-area network and/or in a cloud-computing arrangement or environment, with a source-controlled (e.g., git, gitops, etc.) and container orchestration process. The computer programs (e.g., computer control logic) or software may be stored in memory 252 resident on/in the computing device 250. Such computer programs or software, when executed, may enable the computing device 250 to implement the present methods and exemplary embodiments discussed herein. Accordingly, such computer programs may represent controllers of the computing device 250. Where the present disclosure is implemented using software, the software may be stored in a computer program product or non-transitory computer readable medium and loaded into the computing device 250 using any one or combination of a removable storage drive, an interface for internal or external communication, and a hard disk drive, where applicable.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processor(s) (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the computing device 250 and/or the components of the enterprise network 204 to perform the functions disclosed herein. It will be apparent to persons having skill in the relevant art that such processes result in the computing device 250 and/or the components of the enterprise network 204 being specially configured computing devices uniquely programmed to perform the functions of the exemplary embodiments described herein.

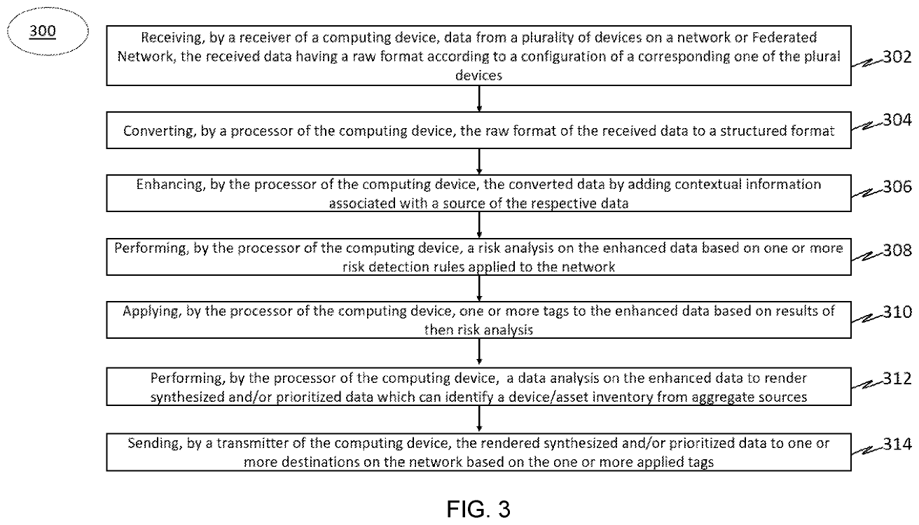

FIG. 3 illustrates a method 300 for risk-based observability of a platform in accordance with an exemplary embodiment of the present disclosure. As shown in FIG. 3, the operation performed by an edge or distributed computing device 202a-202n and/or a server 206 includes receiving, by a receiver of the edge device 202a-202n and/or server 206, data from a plurality of devices on a network, the received data having a raw format according to a configuration of a corresponding one of the plural devices on a network or a Federated Network (Step 302). A processor of the edge device 202a-202n and/or server 206 converts the raw format of the received data to a structured format (Step 304). Next, the processor of the edge device 202a-202n and/or server 206 enhances the converted data by adding contextual information associated with a source of the respective data (Step 306). The method further includes performing, by the processor of the edge device 202a-202n and/or server 206, a risk analysis on the enhanced data based on risk content applied to the network (Step 308) and applying one or more tags to the enhanced data based on results of then risk analysis (Step 310). The processor of the edge device 202a-202n and/or server 206 performs a data analysis on the enhanced data to render synthesized and/or prioritized data which can identify a device/asset inventory from aggregate sources (Step 312). A transmitter of the edge device 202a-202n and/or server 206 sends the rendered synthesized and/or prioritized data to one or more destinations on the network 204 based on the one or more applied tags (Step 314).

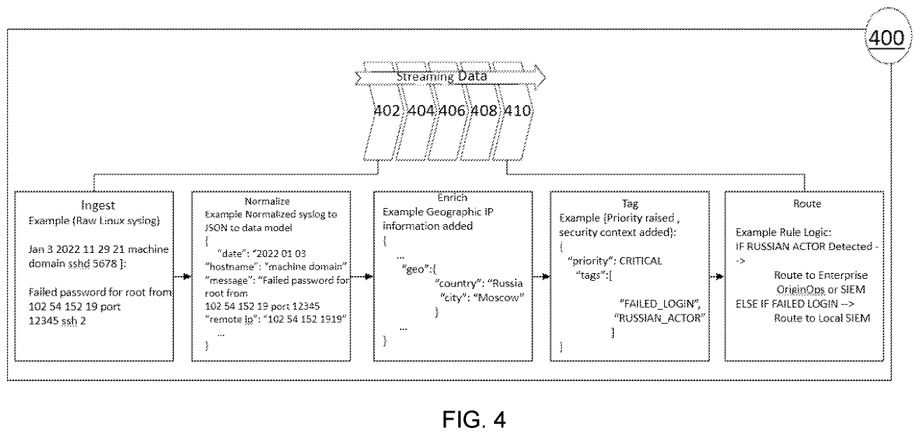

FIG. 4 illustrates a first use case 400 for risk-based observability in accordance with an exemplary embodiment of the present disclosure.

As shown in FIG. 4, the computing device 202a-202n and/or server 206 ingests (e.g., receives) raw and unstructured streaming data from a data source (Stage 402). The streaming data includes a log entry that indicates a failed login attempt from a Russian IP address. Data is raw and unstructured. The computing device 202a-202n and/or server 206 structures and converts the streaming data to a common schema (Stage 404). For example, fields of the streaming data are extracted and mapped to the common schema so that common processing can be applied to the data regardless of source. Next, the normalized data is enrich data to provide context and meaning to the extracted data fields (Stage 406). In this example, geography identifiers are added which designate that the data originated from Moscow, Russia. Next, the enriched data is tagged to identify security risks and incidents based on rules customizable to each deployment (Stage 408). The tags can be identified in the rules and follow the schema specified for each organization or computing environment. According to exemplary embodiments, one rule can apply multiple tags. The computing device 202a-202n performs a data analysis on the enhanced data to render synthesized and/or prioritized data which can identify a device/asset inventory from aggregate sources. (Stage 410) The computing device 202a-202n and/or server 206 routes the data to a destination for evaluation and action appropriate for the identified risk (Stage 412). The routing operation is performed based on contextual security information and rules which determine whether data should be routed to a specified network destination for further system or human processing. As shown in Stage 412, both conditions for contextual security information and rules are met so the data record is sent to a Local STEM system and an Enterprise SIEM system for further processing. According to an exemplary embodiment, tag and routing criteria can be configured using a rule tree language that defines how records get tagged based on their content and context.

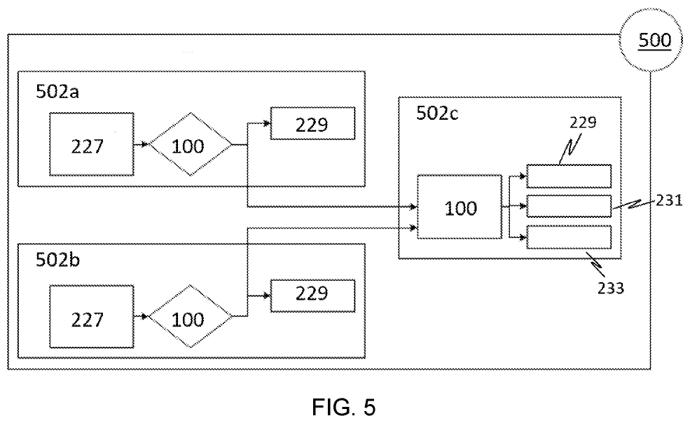

FIG. 5 illustrates a use case 500 for a Federated Data Streaming model in accordance with an exemplary embodiment of the present disclosure.

As shown in FIG. 5, the system 500 can have plural computing environments 502a-502c. Each computing environment 502a-502c can include a combination of software and hardware components configured to perform operations for risk-based observability 100 in accordance with FIG. 1. According to exemplary embodiments of the present disclosure, the computing environments 502a-502b can be on-premises, cloud, or hybrid environments. In performing the risk-based observability operations 100, the computing environments 502a-502c can be configured to tag and route data to different destinations to implement a security strategy of a user or platform. The computing environment 502c can include a server 206 of an enterprise network that receives previously-processed data records (including tags, enrichments, and normalizations) from the computing environments 502a and 502b. Following receipt of the data the server 206 can run further analysis 231, route the analysis result or determination to a SIEM system or Incident Response Team 233, or execute customer-specific business logic 229.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A system for risk-based observability of a platform, the system comprising:
a receiver configured to receive data from plural devices associated with one or more computing environments on a network, the received data having a raw format according to the associated computing environment;
a processor configured to:
convert the raw format of the received data to a structured format;
enhance the converted data by adding contextual information associated with a corresponding one of the plural devices;
perform a risk analysis of the enhanced data based on risk content applied to the network; and
apply one or more tags to the enhanced data based on results of the risk analysis;
perform data analysis on the enhanced data to render synthesized and/or prioritized data for identifying one or more of the plural devices from an aggregate source; and
a transmitter configured to send the rendered synthesized and/or prioritized data to one or more destinations on the network based on the one or more applied tags.

2. The system according to claim 1, wherein the received data is sourced from at least one of: signature-based alerts grouped by application, device, and user; host-based logs;
network-based logs; cyber compliance audits; and network user activity.

3. The system according to claim 1, wherein the structured format includes a common schema.

4. The system according to claim 3, wherein to convert the raw data format of the received data, the processor is configured to:
extract specified fields from the data received from the plural devices according to the common schema.

5. The system according to claim 1, wherein the contextual information includes at least geographic IP information.

6. The system according to claim 1, wherein the risk analysis identifies security risks and incidents according to the risk content of the network.

7. The system according to claim 6, wherein the processor is configured to:
apply the one or more tags to the enhanced data according to a common schema of the structured data format.

8. The system according to claim 1, wherein the processor is configured to:
determine whether the rendered synthesized and/or prioritized data having the one or more applied tags identifies a risk that requires further evaluation; and
determine whether a specified response action is mapped to the identified risk.

9. The system according to claim 8, wherein the rendered synthesized and/or prioritized data is sent to the one or more destinations when further evaluation is required and the specified response action is identified.

10. The system according to claim 1, wherein the network is an enterprise network having a plurality of distributed computing devices.

11. A method for risk-based observability of a platform, the method comprising:
receiving, by a receiver of a computing device, data from plural devices associated with one or more computing environments on a network, the received data having a raw format according to the associated computing environments;
converting, by a processor of the computing device, the raw format of the received data to a structured format;
enhancing, by the processor of the computing device, the converted data by adding contextual information associated with a source of the respective data;
performing, by the processor of the computing device, a risk analysis on the enhanced data based on risk content applied to the network;
applying, by the processor of the computing device, one or more tags to the enhanced data based on results of then risk analysis;
performing, by the processor of the computing device, data analysis on the enhanced data to render synthesized and/or prioritized data for identifying one or more of the plural devices from an aggregate source; and
sending, by a transmitter of the computing device, the rendered synthesized and/or prioritized data to one or more destinations on the network based on the one or more applied tags.

12. The method according to claim 11, wherein the received data includes at least one of: signature-based alerts grouped by application, device, and user; host-based logs; network-based logs; cyber compliance audits; and network user activity.

13. The method according to claim 11, wherein the structured format includes a common schema.

14. The method according to claim 13, wherein converting the raw format of the received data comprises:
extracting, by the processor of the computing device, specified fields from the data received from the plural devices according to the common schema.

15. The method according to claim 11, wherein the contextual information includes at least geographic IP information.

16. The method according to claim 11, wherein performing the risk analysis comprises:
identifying, by the processor of the computing device, security risks and incidents according to the risk content of the network.

17. The method according to claim 16, comprising:
applying, by the processor of the computing device, the one or more tags to the enhanced data according to a common schema of the structured data format.

18. The method according to claim 11, comprising:
determining, by the processor of the computing device:
whether the rendered synthesized and/or prioritized data having the one or more applied tags identifies a risk that requires further evaluation; and
whether a specified response action is mapped to the identified risk.

19. The method according to claim 18, comprising:
sending, by the transmitter of the computing device, the enhanced data to the one or more destinations on the network when the identified risk requires further evaluation and a specified response is mapped to the identified risk.

20. The method according to claim 1, wherein the network is an enterprise network having a plurality of distributed computing devices.

21. A computer readable medium storing program code for performing a method for risk-based observability of a platform, when placed in communicable contact with computing device the program code causing the computing device to perform operations comprising:
receiving, by a receiver of a computing device, data from plural devices associated with one or more computing environments on a network, the received data having a raw format according to the associated computing environment;
converting, by a processor of the computing device, the raw format of the received data to a structured format;
enhancing, by the processor of the computing device, the converted data by adding contextual information associated with a source of the respective data;
performing, by the processor of the computing device, a risk analysis on the enhanced data based on one or more risk detection rules applied to the network;
applying, by the processor of the computing device, one or more tags to the enhanced data using results of the analysis;
performing, by the processor of the computing device, data analysis on the enhanced data to render synthesized and/or prioritized data for identifying one or more of the plural devices from an aggregate source; and
sending, by a transmitter of the computing device, the rendered synthesized and/or prioritized data to one or more destinations on the network based on the one or more applied tags.
